(19) United States
(12) Patent Application Publication
(10) Pub. No.: US 2009/0189508 A1
(43) Pub. Date: Jul. 30, 2009

(54) BACKLIGHT UNIT

(76) Inventors: Jae-Sang Ha, Suwon-si (KR); Sang-Jin Lee, Suwon-si (KR)

Correspondence Address: CHRISTIE, PARKER & HALE, LLP, PO BOX 7068, PASADENA, CA, 91109-7068, US

(21) Appl. No.: 12/341,803

(22) Filed: Dec. 22, 2008

(30) Foreign Application Priority Data
Jan. 29, 2008 (KR) 10-2008-0009020

(51) Int. Cl. H01J 1/00

(52) U.S. Cl. 313/494

(57) ABSTRACT

A backlight unit includes a base substrate and a first electrode which is formed on the base substrate in a line. An electron emission layer is formed on the first electrode in the substantially same pattern as the first electrode. A second electrode supporter is formed on the base substrate and disposed on sides of the first electrode and the electron emission layer. A second electrode is formed on the second electrode supporter and has an aperture pattern. A third electrode is formed on the front substrate for accelerating electrons emitted from the electron emission layer. A phosphor layer is formed on the third electrode responsive to electrons accelerated by the third electrode.

### CROSS-REFERENCE TO RELATED PATENT APPLICATION

This application claims priority to and the benefit of Korean Patent Application No. 10-2008-0009020, filed on Jan. 29, 2008, in the Korean Intellectual Property Office, the entire content of which is incorporated herein by reference.

### BACKGROUND OF THE INVENTION

1. Field of the Invention

The present invention relates to electron emission type backlight units, and, more particularly, to electron emission device structures of the backlight units.

2. Description of the Related Art

Generally, electron emission devices have a hot cathode or a cold cathode as an electron emission layer. The electron emission devices that have a cold cathode include field emission device (FED) type devices, surface conduction emitter (SCE) type devices, metal insulator metal (MIM) type devices, metal insulator semiconductor (MIS) type devices, ballistic electron surface emitting (BSE) type devices, etc.

In FED type devices, when a material having a low work function or a high β function is used as an electron emission layer, the material readily emits electrons in a vacuum due to an electric field formed between two or more electrodes. FED type devices that employ a tapered tip structure formed of Mo, Si, etc., as a main component, a carbon group material such as graphite, diamond like carbon (DLC), etc., or a nano structure such as nanotubes, nano wires, etc., have been developed.

FIG. 1 is a diagram illustrating a conventional electron emission type backlight unit 100 including a conventional electron emission device 101.

As illustrated in FIG. 1, the electron emission type backlight unit 100 includes the electron emission device 101 and a front panel 102, which are disposed in parallel and form a luminance space 103 which is in a vacuum state. Spacers 60 maintain a space between the electron emission device 101 and the front panel 102.

The electron emission device 101 includes a base substrate 10, a first electrode 20, a second electrode 30, an insulating layer 40, and an electron emission layer 50.

The first and second electrodes 20, 30 are disposed so as to cross each other on the base substrate 10, and the insulating layer 40 is disposed between the first and second electrodes 20, 30 and electrically insulates the first and second electrodes 20, 30. Also, electron emission layer holes 41 are formed in areas of the insulating layer 40 where the first and second electrodes 20, 30 cross each other. Respective electron emission layers 50 are disposed inside the electron emission layer holes 41.

The front panel 102 includes a front substrate 90, which can penetrate visible light, a phosphor layer 70, which is disposed on the front substrate 90 and generates the visible light by being excited by electrons emitted from the electron emission device 101, and a third electrode 80, which accelerates the electrons emitted from the electron emission device 101 toward the phosphor layer 70.

In the conventional electron emission device 101, electrons are emitted from the electron emission layers 50 by an electric field formed between the first and second electrodes 20, 30. The electrons are emitted from the electron emission layer 50 that is associated with an electrode that operates as a cathode from among the first and second electrodes 20, 30. First, the emitted electrons move towards an electrode that operates as an anode, and then accelerate towards the phosphor layer 70 by a strong electric field of the third electrode 80.

However, the electrons cannot be uniformly emitted since a hot spot or an arc may be generated by high pressure on the third electrode 80. Also, since a high voltage cannot be applied between the first and second electrodes 20, 30, the electron emission efficiency of the electron emission layers 50 cannot be maximized, and thus the electron emission layers 50 are over loaded. Accordingly, the durability of the electron emission layers 50 is reduced.

### SUMMARY OF THE INVENTION

In accordance with the present invention an electron emission device is provided for maintaining stability of a backlight unit at high pressure.

In an exemplary embodiment an electron emission type backlight unit includes the electron emission device, wherein high pressure can be applied to an anode and desired luminance can be obtained.

According to an exemplary embodiment of the present invention, there is provided a backlight unit which includes a base substrate spaced apart from a front substrate. A first electrode is formed on the base substrate in a line. An electron emission layer is formed on the first electrode in the substantially same pattern as the first electrode. A second electrode supporter is formed on the base substrate and disposed at sides of the first electrode and the electron emission layer. A second electrode is formed on the second electrode supporter and has an aperture pattern. A third electrode is formed on the front substrate for accelerating electrons emitted form the electron emission layer. A phosphor layer is formed on the third electrode and is responsive to electrons accelerated by the third electrode.

The aperture pattern may have a circular shape.

The diameter of the aperture pattern may be in the range between 50 μm and 500 μm.

The aperture pattern may have a polygonal shape.

The width of the aperture pattern may be in the range between 50 μm and 500 μm.

The electron emission layer and the second electrode may be spaced apart from each other by the second electrode supporter.

The second electrode supporter may include an insulating material.

The electron emission layer may be continuously formed on the top of the first electrode.

The electron emission layer may be formed in a plurality of patterns that are spaced apart from each other along a length direction of the first electrode.

### BRIEF DESCRIPTION OF THE DRAWINGS

FIG. 1 is a diagram illustrating a conventional electron emission type backlight unit.

FIG. 2 is a partial perspective view illustrating an electron emission device according to an embodiment of the present invention.

FIG. 3 is a diagram illustrating an electron emission type backlight unit including the electron emission device of FIG. 2, according to an embodiment of the present invention.

FIG. 4 is a cross-sectional view taken along the line IV-IV of FIG. 3.

FIG. 5 is a partial perspective view illustrating an electron emission device according to another embodiment of the present invention.

FIG. 6 is a partial perspective view illustrating an electron emission device according to another embodiment of the present invention.

FIG. 7 is a partial perspective view illustrating an electron emission device according to another embodiment of the present invention.

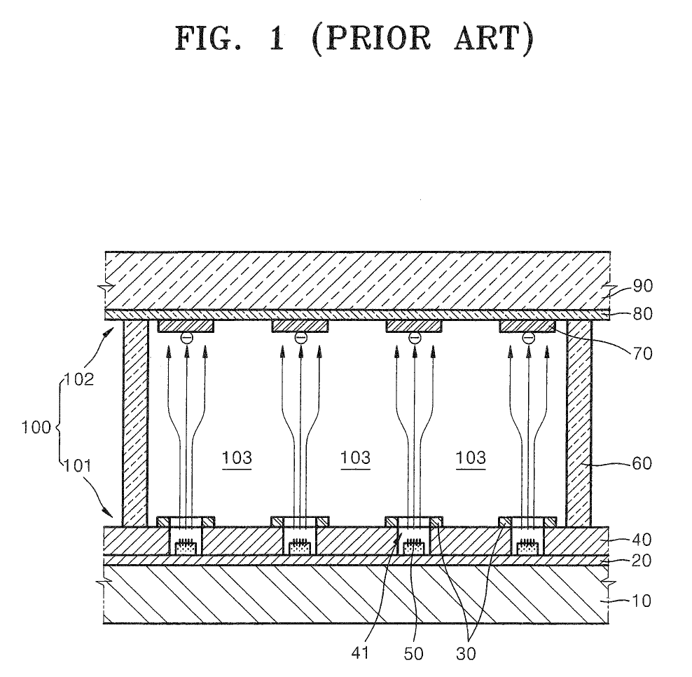

### DETAILED DESCRIPTION OF THE INVENTION

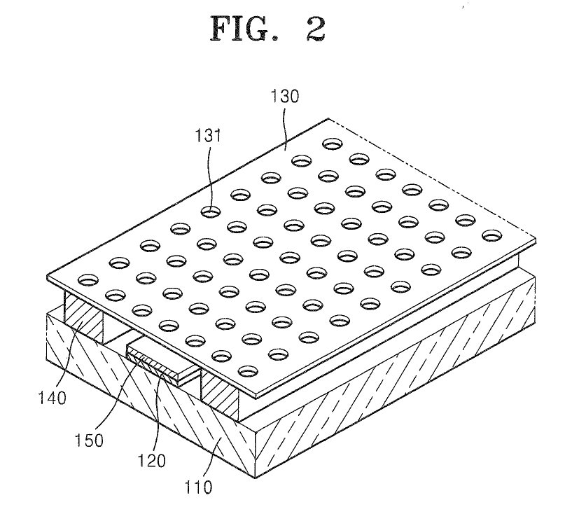

Referring to FIG. 2, the electron emission device includes a base substrate 110, a first electrode 120, a second electrode 130, and an electron emission layer 150.

The base substrate 110 has a plate shape with a predetermined thickness. The base substrate 110 may be formed of quartz glass, glass containing impurities such as small amount of Na, plate glass, an SiO₂ coated glass substrate, or an aluminum oxide or ceramic substrate. Also, when a flexible display apparatus is realized, the base substrate may be formed of a flexible material.

The first electrode 120 extends in one direction on the base substrate 110, and is formed of a general electric conductive material. For example, the first electrode 120 may be formed of a metal, such as Al, Ti, Cr, Ni, Au, Ag, Mo, W, Pt, Cu, and Pd, or an alloy thereof. Alternatively, the first electrode 120 may be formed of a printed conductive material containing glass and a metal, such as Pd, Ag, RuO₂, and Pd—Ag, or metal oxide thereof. Alternatively, the first electrode 120 may be formed of a transparent conductor, such as ITO, In₂O₃, and SnO₂, or a semiconductor material, such as polycrystalline silicon.

The electron emission layer 150 is disposed on the top of the first electrode 120, and is electrically connected to the first electrode 120. An electron emission material is included in the electron emission layer 150. The electron emission material may be a carbon nano tube (CNT) of which the work function is low and the β function is high. Specifically, the CNT has an excellent electron emission characteristic, and thus can be efficiently operated at low voltage. Accordingly, using the CNT as an electron emission layer is particularly advantageous in large sized apparatuses. However, the electron emission material is not limited to CNT, and may include a carbon group material, such as graphite, a diamond, and diamond-like carbon, or a nano material, such as a nano tube, a nano wire, and a nano rod. Alternatively, the electron emission material may include carbide conduction carbon.

According to the electron emission device in FIG. 2, the electron emission layer 150 is formed on the entire first electrode 120, but this aspect of the present invention is not limited thereto. For example, the electron emission layer 150 may be formed on the first electrode 120 in a predetermined interval.

Second electrode supporters 140 are formed on both sides of the first electrode 120. The second electrode supporters 140 may be formed of a conventional insulating material. For example, the insulating layer may be silicon oxide, silicon nitride, frit, or the like. Examples of the frit include PbO—SiO₂ group frit, PbO—B₂O₃—SiO₂ group frit, ZnO—SiO₂ group frit, ZnO—B₂O₃—SiO₂ group frit, Bi₂O₃—SiO₂ group frit, and Bi₂O₃—B₂O₃—SiO₂ group frit, but are not limited thereto. The second electrode supporters 140 insulate the base substrate 110 and the second electrode 130. Also, the second electrode supporters 140 form a seating location of the second electrode so that the second electrode 130 is spaced apart from the first electrode 120 and the electron emission layer 150.

As described above, by including the second electrode supporters 140, which form the seating location of the second electrode 130, the second electrode 130 can be formed without forming a separate groove in the base substrate 110.

The second electrode 130 is disposed on the second electrode supporters 140. The second electrode 130 may be formed of an electric conductive material forming a grid. For example, the second electrode 130 may be formed of a metal, such as Al, Ti, Cr, Ni, Au, Ag, Mo, W, Pt, Cu, and Pd, and an alloy thereof. Alternatively, the second electrode 130 may be formed of a printed conductor containing glass and a metal, such as Pd, Ag, RuO₂, and Pd—Ag, or metal oxide thereof. Alternatively, the second electrode 130 may be formed of a transparent conductor, such as ITO, In₂O₃, and SnO₂, or a semiconductor material, such as polycrystalline silicon.

The second electrode 130 has a grid structure wherein a predetermined aperture pattern 131 is repeatedly formed. As illustrated in FIG. 2, the aperture pattern 131 is a structure where circular aperture patterns are repeated. Accordingly, by forming the aperture pattern 131 having the circular shape, loss generated by the electrons emitted from the electron emission layer 150 contacting the second electrode 130 can be minimized. Also, the second electrode 130 can be easily manufactured.

Here, the diameter of each aperture pattern 131 is approximately between 50 μm and 500 μm considering the size and manufacturing convenience of the electron emission layer 150.

The aperture pattern 131 of FIG. 2 is formed in a circular shape and the diameter of the aperture patterns 131 is approximately between 50 μm and 500 μm, but the shape and the diameter of the aperture pattern 131 are not limited thereto. In other words, each of the aperture patterns 131 may have various shapes and forms considering factors, such as the size, electron emission efficiency, light emitting efficiency, luminance, manufacturing expenses, and manufacturing difficulty of the electron emission layer 150.

By using a second electrode 130 having the aperture pattern 131, a high voltage can be easily applied since an arc protective layer is formed, and thus the electrons can be uniformly emitted. Also, since the stability at high pressure can be maintained, the electron emission efficiency can be maximized while the light emitting uniformity increases and durability of the electron emission layer 150 increases. Moreover, as the structures of the first and second electrodes 120, 130 are simplified, the manufacturing processes are also simplified and the manufacturing expenses decrease.

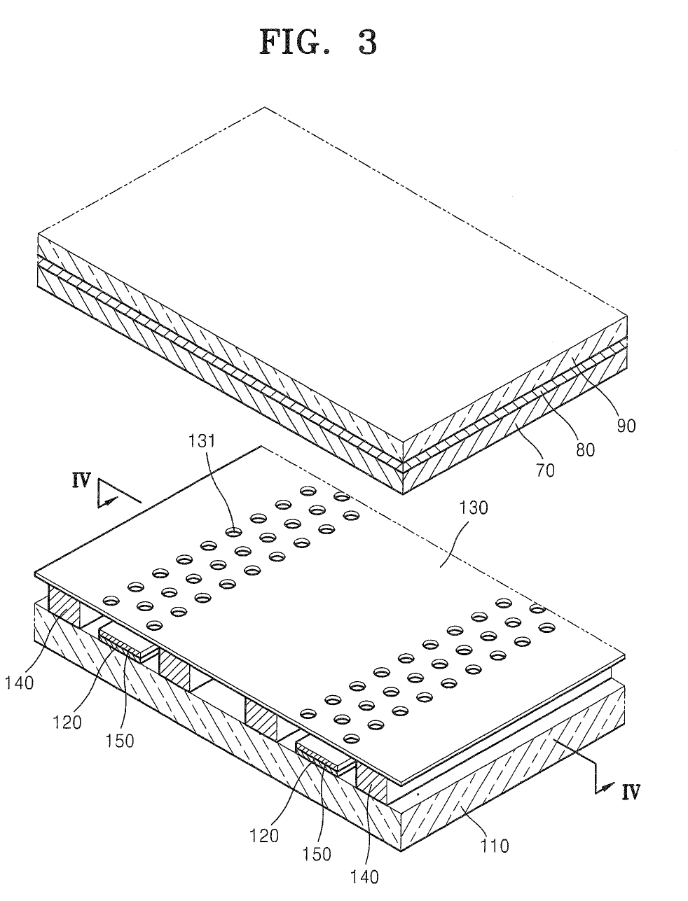

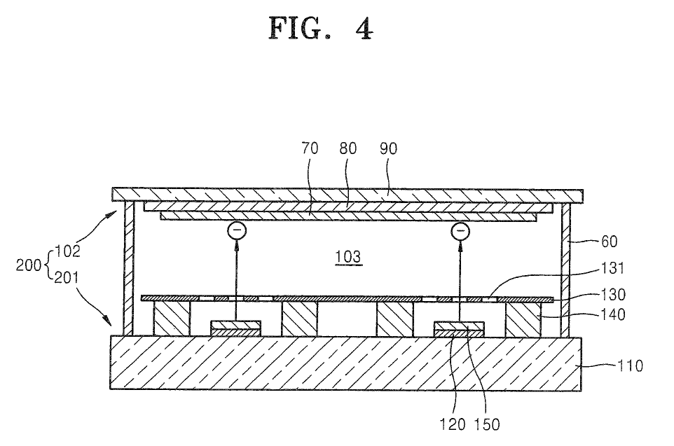

FIG. 3 is a diagram illustrating an electron emission type backlight 200 unit including the electron emission device of FIG. 2, according to an embodiment of the present invention. FIG. 4 is a cross-sectional view taken along the line IV-IV of FIG. 3.

As illustrated in FIGS. 3 and 4, the electron emission type backlight unit 200 includes the electron emission device 201 of FIG. 2 and a front panel 102, which is disposed in front of the electron emission device 201.

The electron emission device 201 has been described with reference to FIG. 2, and thus a detailed description thereof will be omitted. An aperture pattern 131 of the second electrode 130 may be formed throughout the second electrode 130 as illustrated in FIG. 2, or only on the part where the electron emission layer 150 is formed as illustrated in FIG. 3. In addition, neighboring rows of the aperture pattern 130 may be disposed in aligned rows as illustrated in FIG. 2, or in alternatingly aligned rows as illustrated in FIG. 3.

The front panel 102 includes a front substrate 90, which can transmit visible light, a phosphor layer 70, which is disposed on the front substrate 90 and generates visible light by being excited by the electrons emitted from the electron emission device 201, and a third electrode 80, which accelerates the electrons emitted from the electron emission device 201 towards the phosphor layer 70.

The front substrate 90 may be formed of the same material as the base substrate 110 described above, and visible light may pass through the front substrate 90.

The third electrode 80 may be formed of the same material as the first or second electrode 120 or 130 described above.

The phosphor layer 70 is formed of a cathode luminescence (CL) type phosphor substance, which generates the visible light by being excited by the accelerated electrons. Examples of the phosphor substance include red light phosphor substance, such as SrTiO₃:Pr, Y₂O₃:Eu, and Y₂O₃S:Eu, green light phosphor substance, such as Zn(Ga,Al)₂O₄:Mn, Y₃(Al,Ga)₅O₁₂:Tb, Y₂SiO₅:Tb, and ZnS:Cu,Al, and blue light phosphor substance, such as Y₂SiO₅:Ce, ZnGa₂O₄, and ZnS:Ag,Cl. However, the examples of the phosphor substance are not limited to the above.

In order for the electron emission type backlight unit 200 to normally operate, a space 103 between the phosphor layer 70 and the electron emission device 201 needs to be maintained in a vacuum state. Accordingly, a spacer 60, which maintains the space 103 between the phosphor layer 70 and the electron emission device 201, and a glass frit (not shown), which seals the space 103, may be further included in the electron emission type backlight unit 200. The glass frit is disposed around the space 103 in order to seal the space 103.

The electron emission type backlight unit 200 having the above structure operates as follows. A negative voltage is applied to the first electrode 120 and a positive voltage is applied to the second electrode 130 of the electron emission device 201, and thus electrons are emitted from the electron emission layer 150 toward the second electrode 130 by an electric field formed between the first and second electrodes 120, 130. When a positive voltage much bigger than the positive voltage applied to the second electrode 130 is applied to the third electrode 80, the electrons emitted from the electron emission layer 150 accelerate toward the third electrode 80. Visible light is generated as the electrons excite the phosphor layer 70 adjacent to the third electrode 80. The emission of the electrons can be controlled by the voltage applied to the second electrode 130.

The voltage applied to the first electrode 120 is not limited to the negative voltage, and any type of voltage can be applied as long as a suitable electric potential difference is formed between the first and second electrodes 120, 130 in order to emit the electrons.

The electron emission type backlight unit 200 illustrated in FIG. 3 can be used as a backlight unit of a non-emissive display device, such as TFT-LCD, as a surface light source.

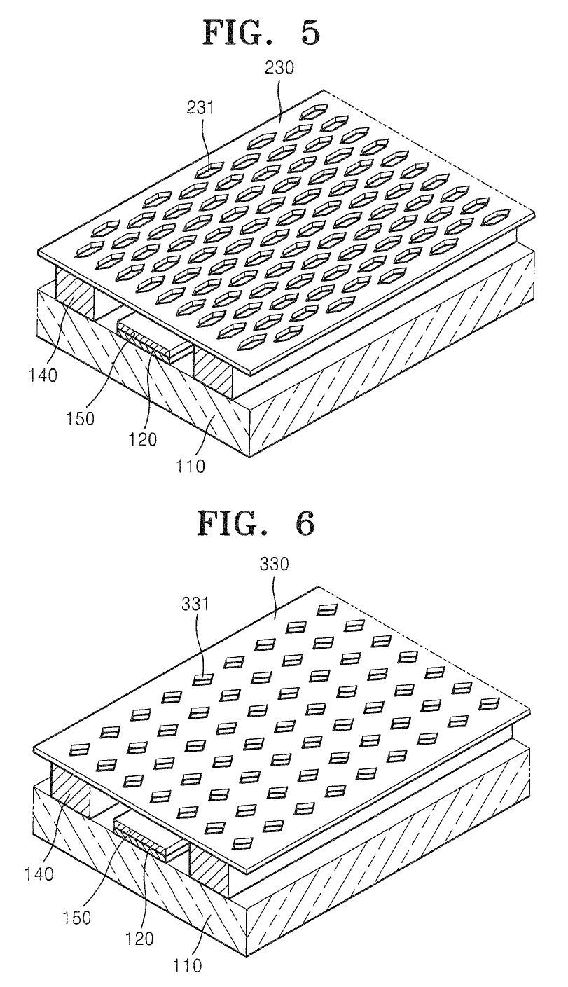

FIG. 5 is a partial perspective view illustrating an electron emission device according to another embodiment of the present invention.

As illustrated in FIG. 5, the electron emission device includes a base substrate 110, a first electrode 120, a second electrode 230, and an electron emission layer 150. The first electrode 120 extends in one direction on the base substrate 110, and the electron emission layer 150 is disposed on the top of the first electrode 120 and is electrically connected to the first electrode 120. Also, second electrode supporters 140 are formed on both sides of the first electrode 120. The second electrode 230 is disposed on the second electrode supporters 140. The second electrode 230 has a grid structure wherein a predetermined aperture pattern 231 is repeatedly formed, and may be formed of an electric conductive material forming a grid.

The current embodiment is different from the previous embodiment as the aperture pattern 231 of the second electrode 230 is a polygon, such as a hexagon. The aperture pattern 231 having the hexagon shape is repeatedly formed in the second electrode 230, and thus the second electrode 230 has a hive structure. Such a structure requires less materials while having a wide volume and high degree of strength. Accordingly, by forming the aperture pattern 231 having the hexagon shape, loss generated by the electrons emitted from the electron emission layer 150 contacting the second electrode 230 can be minimized.

Here, the width (a distance between two facing sides) of each aperture pattern 231 is approximately between 50 μm and 500 μm considering the size and manufacturing convenience of the electron emission layer 150.

By using the second electrode 230 having the aperture pattern 231, a high voltage can be easily applied since an arc protective layer is formed, and thus the electrons can be uniformly emitted. Also, since the stability at high pressure is guaranteed, the electron emission efficiency is maximized while the light emitting uniformity increases and durability of the electron emission layer 150 increases. Moreover, as the structures of the first and second electrodes 120, 230 are simplified, the manufacturing processes are also simplified and the manufacturing expenses decrease.

FIG. 6 is a partial perspective view illustrating an electron emission device according to yet another embodiment of the present invention.

As illustrated in FIG. 6, the electron emission device includes a base substrate 110, a first electrode 120, a second electrode 330, and an electron emission layer 150. The first electrode 120 extends in one direction on the base substrate 110, and the electron emission layer 150 is disposed on the top of the first electrode 120 and is electrically connected to the first electrode 120. Also, second electrode supporters 140 are formed on both sides of the first electrode 120. The second electrode 330 is disposed on the second electrode supporters 140. The second electrode 330 has a grid structure wherein a predetermined aperture pattern 331 is repeatedly formed, and may be formed of an electric conductive material forming a grid.

The current embodiment is different from the previous embodiments as the second electrode 330 such that the aperture pattern 331 has a tetragonal shape is repeatedly formed in the second electrode 330. Such a structure requires less materials while having a wide volume and high degree of strength. Accordingly, by forming the aperture pattern 331 having the tetragonal shape, loss generated by the electrons emitted from the electron emission layer 150 contacting the second electrode 330 can be minimized. Also, the second electrode 330 can be easily manufactured.

Here, the width (a distance between two facing sides) of each aperture pattern 331 is approximately between 50 μm and 500 mm considering the size and manufacturing convenience of the electron emission layer 150.

By using the second electrode 330 having the aperture pattern 331, a high voltage can be easily applied since an arc protective layer is formed, and thus the electrons can be uniformly emitted. Also, since the stability at high pressure is guaranteed, the electron emission efficiency is maximized while the light emitting uniformity increases and durability of the electron emission layer 150 increases. Moreover, as the structures of the first and second electrodes 120, 330 are simplified, the manufacturing processes are also simplified and the manufacturing expenses decrease.

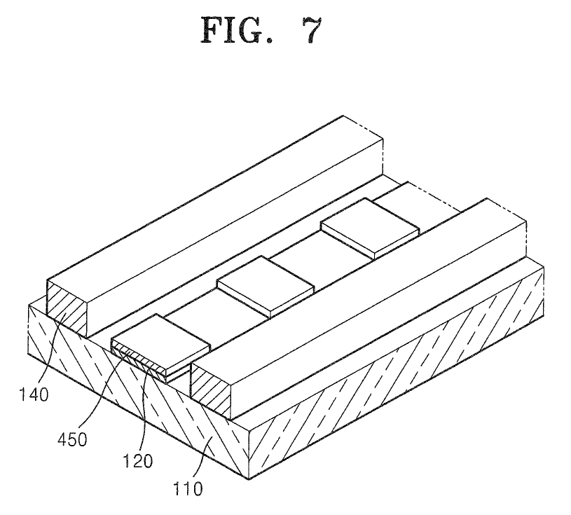

FIG. 7 is a partial perspective view illustrating an electron emission device according to still another embodiment of the present invention.

As illustrated in FIG. 7, the electron emission device includes a base substrate 110, a first electrode 120, a second electrode (not shown), and an electron emission layer 450. The first electrode 120 extends in one direction on the base substrate 110, and the electron emission layer 450 is disposed on the top of the first electrode 120 and is electrically connected to the first electrode 120. Also, second electrode supporters 140 are formed on both sides of the first electrode 120. The second electrode is disposed on the second electrode supporters 140. The second electrode has a grid structure wherein a predetermined aperture pattern (not shown) is repeatedly formed, and may be formed of an electric conductive material forming a grid.

The current embodiment is different from the previous embodiments as the electron emission layer 450 is formed on the first electrode 120 in a predetermined interval. In other words, the electron emission layer 450 is formed in a plurality of patterns that are spaced apart form each other along a length direction of the first electrode 120. Accordingly, the electron emission layer 450 can be easily manufactured, and manufacturing costs can be reduced.

According to the backlight unit of the present invention, electrons can be uniformly emitted, a high voltage can be applied to an anode, and the generation of arcs can be prevented.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A backlight unit comprising:
a base substrate;
a front substrate spaced apart from the base substrate;
a first electrode on the base substrate in a line;
an electron emission layer on the first electrode in a substantially same pattern as the first electrode;
a second electrode supporter on the base substrate at sides of the first electrode and the electron emission layer;
a second electrode on the second electrode supporter and having an aperture pattern;
a third electrode on the front substrate for accelerating electrons emitted from the electron emission layer; and
a phosphor layer on the third electrode responsive to electrons accelerated by the third electrode.

2. The backlight unit of claim 1, wherein the aperture pattern has a circular shape.

3. The backlight unit of claim 2, wherein the diameter of the aperture pattern is in the range between 50 μm and 500 μm.

4. The backlight unit of claim 1, wherein the aperture pattern has a polygonal shape.

5. The backlight unit of claim 4, wherein the width of the aperture pattern is in the range between 50 μm and 500 μm.

6. The backlight unit of claim 1, wherein the electron emission layer and the second electrode are spaced apart from each other by the second electrode supporter.

7. The backlight unit of claim 6, wherein the second electrode supporter comprises an insulating material.

8. The backlight unit of claim 1, wherein the electron emission layer is continuously formed on a top of the first electrode.

9. The backlight unit of claim 1, wherein the electron emission layer is in a plurality of patterns spaced apart from each other along a length direction of the first electrode.
